(19) United States
(12) Patent Application Publication
(10) Pub. No.: US 2019/0271811 A1
(43) Pub. Date: Sep. 5, 2019

(54) Optical-Electrical Complex Connector

(71) Applicant: Tyco Electronics Japan G.K., Kanagawa (JP)

(72) Inventors: Shoji Kawashima, Kanagawa (JP); Shigeru Kobayashi, Kanagawa (JP)

(73) Assignee: Tyco Electronics Japan G.K., Kanagawa (JP)

(21) Appl. No.: 16/288,170

(22) Filed: Feb. 28, 2019

(30) Foreign Application Priority Data
Mar. 1, 2018 (JP) 2018-036207

(51) Int. Cl. G02B 6/38; H01R 24/58; G02B 6/42; H01R 13/24

(52) U.S. Cl. CPC G02B 6/3817; H01R 24/58; G02B 6/3874; G02B 6/3897; H01R 13/24; G02B 6/42

(57) ABSTRACT

An optical-electrical hybrid connector comprises an electrical terminating portion of each of a pair of electrical wires for differential signal transmission and an optical terminating portion of an optical fiber for optical signal transmission. The optical terminating portion is covered with a ferrule made of an electrically conductive material. The optical terminating portion is arranged in a position separated from the electrical terminating portion of each of the electrical wires by a distance producing an impedance matched with an impedance of a portion of each of the electrical wires connected to the electrical terminating portions and extending outside of the optical-electrical hybrid connector.

### CROSS-REFERENCE TO RELATED APPLICATION

This application claims the benefit of the filing date under 35 U.S.C. § 119(a)-(d) of Japanese Patent Application No. 2018-036207, filed on Mar. 1, 2018.

### FIELD OF THE INVENTION

The present invention relates to a connector and, more particularly, to an optical-electrical hybrid connector retaining a terminating portion of an electrical wire and a terminating portion of an optical fiber.

### BACKGROUND

Automated driving of automobiles has been developing rapidly. In order to achieve automated driving, it is necessary to install a camera, many sensors, and the like, in an automobile and transmit a large number of signals. An optical fiber capable of high speed transmission of optical signals is often used. An automobile, however, also contains many pieces of equipment transmitting electrical signals. Automobiles therefore often require both an electrical wire for electrical signal transmission and an optical fiber for optical signal transmission.

If an electrical connector for the electrical wire and an optical connector for the optical fiber are separately provided, the number of connectors increases, routing of wiring becomes complicated, and workloads in assembly correspondingly increase. A single connector has been developed that transmits both an electrical signal and an optical signal. For example, Japanese Patent Application No. S62-134611 discloses an optical-electrical hybrid connector retaining both a terminating portion of the electrical wire and a terminating portion of the optical fiber. The optical-electrical hybrid connector disclosed in JP S62-134611 has a structure in which the terminating portion of the electrical wire is connected to a ferrule surrounding the terminating portion of the optical fiber in a housing of the connector.

In an electrical connector retaining the terminating portion of the electrical wire of a twisted pair for differential signal transmission, the twisted pair is untwisted and two electrical wires are separated from each other. A contact is connected to the terminating portion of each electrical wire. Without any particular countermeasure, impedance mismatching occurs between a portion of the twisted pair outside the electrical connector and the terminating portion inside the electrical connector, which may degrade frequency characteristics. In order to avoid this, conventionally, impedance matching is achieved by providing a shield and a ground pin in the electrical connector.

An optical-electrical hybrid connector retains the terminating portion of the optical fiber and the terminating portion of the electrical wire for differential signal transmission. When this optical-electrical hybrid connector is configured, for example, the configuration is made such that the above structure of the electrical connector is incorporated, and further the terminating portion of the optical fiber is also retained. The structure of the connector becomes complicated and a size of the connector increases. This problem is not limited to the case where the optical-electrical hybrid connector is used in an automobile, but is generally a problem common to the use of an optical-electrical hybrid connector for retaining both the terminating portion of the electrical wire for differential signal transmission and the terminating portion of the optical fiber for optical signal transmission.

### SUMMARY

An optical-electrical hybrid connector comprises an electrical terminating portion of each of a pair of electrical wires for differential signal transmission and an optical terminating portion of an optical fiber for optical signal transmission. The optical terminating portion is covered with a ferrule made of an electrically conductive material. The optical terminating portion is arranged in a position separated from the electrical terminating portion of each of the electrical wires by a distance producing an impedance matched with an impedance of a portion of each of the electrical wires connected to the electrical terminating portions and extending outside of the optical-electrical hybrid connector.

### BRIEF DESCRIPTION OF THE DRAWINGS

The invention will now be described by way of example with reference to the accompanying Figures, of which:

FIG. 1A is a perspective view of a first connector according to an embodiment;

FIG. 1B is a perspective view of a second connector according to an embodiment;

FIG. 2 is a top view of the first connector and the second connector in a mated state without a first housing of the first connector and a second housing of the second connector;

FIG. 3A is a front view of an arrangement of a plurality of contacts and a plurality of ferrules in the first connector;

FIG. 3B is a front view of another arrangement of the contacts and the ferrules in the first connector;

FIG. 3C is a front view of another arrangement of the contacts and the ferrules in the first connector;

FIG. 3D is a front view of another arrangement of the contacts and one ferrule in the first connector;

FIG. 3E is a front view of another arrangement of the contacts and one ferrule in the first connector; and

FIG. 3F is a front view of another arrangement of the contacts and one ferrule in the first connector.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will convey the concept of the invention to those skilled in the art.

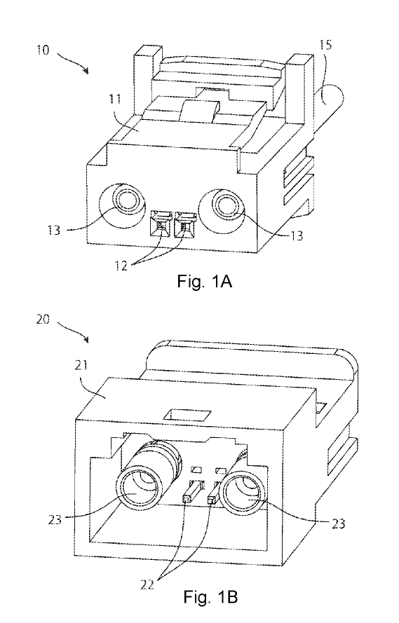

A first connector 10 according to an embodiment is shown in FIG. 1A and a second connector 20 according to an embodiment is shown in FIGS. 1B and 1B configured to mate with the first connector 10. FIGS. 1A and 1B show the faces of both the first connector 10 and the second connector 20 on which they mate with the mating connector. Each of the first connector 10 and the second connector 20 is an optical-electrical hybrid connector.

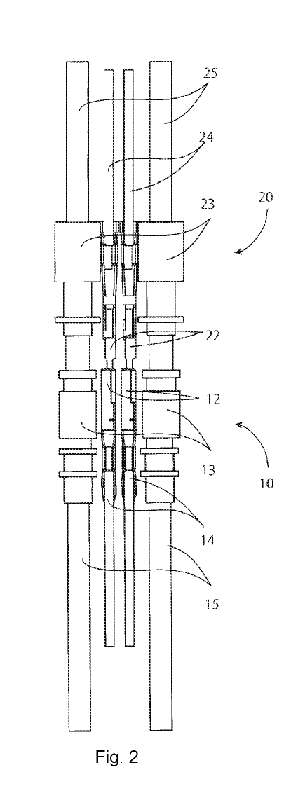

The first connector 10, as shown in FIG. 1A, has a pair of female electrically-conductive contacts 12, 12 and a pair of male ferrules 13, 13 retained in a first housing 11. The male ferrules 13, 13 are arranged in the first housing 11 with both the contacts 12, 12 positioned laterally in between the ferrules 13, 13. The contacts 12, 12 are contacts for differential signal transmission and are connected to respective electrical terminating portions of two first electrical wires 14, 14, as shown in FIG. 2. The ferrules 13, 13 are formed of a metal material and retain optical terminating portions of first optical fibers 15, 15 therein, as shown in FIG. 2.

The second connector 20, as shown in FIG. 1B, has a pair of male electrically-conductive contacts 22, 22 and a pair of female ferrules 23, 23 retained in a second housing 21. The ferrules 23, 23 are arranged in the second housing 21 with both the contacts 22, 22 positioned laterally in between the ferrules 23, 23. The contacts 22, 22 are contacts for differential signal transmission and are connected to respective terminating portions of two second electrical wires 24, 24, as shown in FIG. 2. The ferrules 23, 23 are formed of a metal material and retain terminating portions of second optical fibers 25, 25 therein, as shown in FIG. 2.

The first connector 10 and the second connector 20 are shown in a mated state, with the first housing 11 and the second housing 21 omitted, in FIG. 2. The male contacts 22, 22 of the second connector 20 are respectively inserted in the female contacts 12, 12 of the first connector 10. Thereby, each of the first electrical wires 14, 14 extending outside from the first connector 10 and each of the second electrical wires 24, 24 extending outside from the second connector 20 are electrically connected to each other. The male ferrules 13, 13 of the first connector 10 and the female ferrules 23, 23 of the second connector 20 are also connected as to be capable of optical signal transmission between the first optical fibers 15, 15 and the second optical fibers 25, 25.

The female contacts 12, 12 are connected to the terminating portions of the first electrical wires 14, 14 of the first connector 10 and the male contacts 22, 22 are connected to the terminating portions of the second electrical wires 24, 24 of the second connector 20. Portions of the first electrical wires 14, 14, extending outside the first connector 10 and portions of the second electrical wires 24, 24 extending outside the second connector 20 are stranded into a twisted pair cable. The environments of the first electrical wires 14, 14 and the second electrical wires 24, 24 inside the first connector 10 and the second connector 20 and the environments thereof outside the first connector 10 and the second connector 20 are significantly different. Accordingly, impedance mismatching between the inside and outside of the first connector 10 and the second connector 20 may occur.

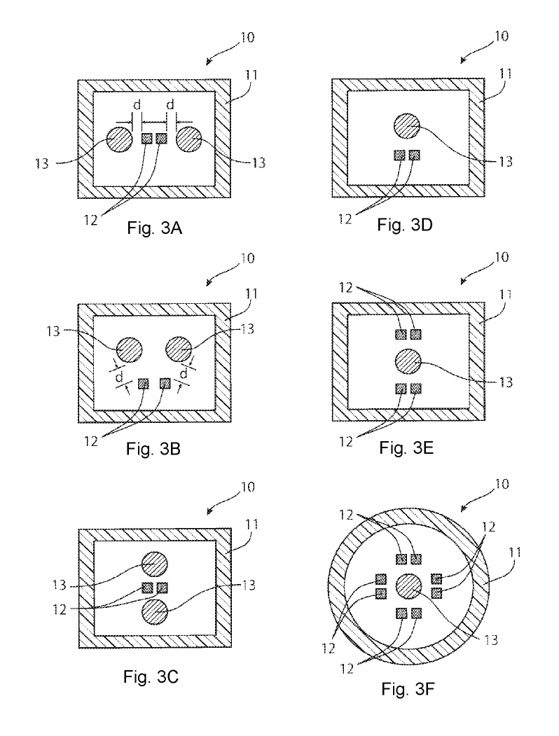

The ferrules 13, 13; 23, 23 are made of metal to match impedances; the ferrules 13, 13; 23, 23 are arranged in positions at equal distances from the electrical wires 14, 14; 24, 24 and contacts 12, 12; 22, 22 and in positions at distances d, d matching the impedances, as shown in FIGS. 3A-3F. In an ordinary electrical connector, impedance matching is achieved by covering an electrical wire and contact with a shield keeping an appropriate distance therefrom. In the connectors 10, 20, the ferrules 13, 13, 23, 23, which are essential elements for optical connectors, are used for impedance mismatching, rendering an additional element for matching the impedances, such as a shield, unnecessary.

FIGS. 3A-3F show a variety of embodiments with different arrangements of the female contacts 12, 12 and the male ferrules 13, 13 in the first connector 10. The embodiments apply equally to different arrangements of the male contacts 22, 22 and the female ferrules 23, 23 in the second connector 20. Further, the embodiments are merely exemplary, and other arrangements of the contacts 12, 12, 22, 22 and the ferrules 13, 13, 23, 23 are possible within the scope of the present invention.

FIG. 3A shows the contacts 12, 12 and the ferrules 13, 13 in an arrangement similar to the arrangement shown in FIGS. 1 and 2. In this arrangement, by setting appropriately the distance d between the contacts 12, 12 and the ferrules 13, 13 adjacent to each other, impedances are matched in the connector 10.

In FIG. 3B, the contacts 12, 12 and the ferrules 13, 13 are arranged in vertically-shifted positions, as compared with the arrangement in FIG. 3A. In this arrangement, by setting appropriately the distance d between the contacts 12, 12 and the ferrules 13, 13 adjacent to each other, impedances are matched in the connector 10.

FIG. 3C shows an embodiment in which the pair of contacts 12, 12 placed laterally are arranged between the ferrules 13, 13 placed vertically. In this arrangement, by arranging the ferrules 13, 13 in positions separated from the contacts 12, 12 by an appropriate distance, the impedances can be matched.

FIG. 3D is an embodiment in which the contacts 12, 12 are arranged laterally, and thereabove one ferrule 13 is arranged in a position at equal distances from both contacts 12, 12. In this arrangement, by arranging the ferrule 13 in a position separated from the contacts 12, 12 by an appropriate distance, the impedances can be matched.

FIG. 3E is an embodiment in which two pairs of contacts 12, 12 are arranged in vertically-separated positions, respectively, and one ferrule 13 is arranged in a central position at equal distances from all four contacts 12. Also in this arrangement, by arranging each contact 12 in a position separated from the central ferrule 13 by an appropriate distance, the impedances can be matched.

FIG. 3F is an embodiment in which one ferrule 13 is arranged at a center of the housing 11 having a circular shape, and four pairs of contacts 12 are arranged in positions at equal distances from the ferrule 13. Also in this arrangement, by arranging each contact 12 in a position separated from the central ferrule 13 by an appropriate distance, the impedances can be matched.

What is claimed is:

1. An optical-electrical hybrid connector, comprising:
an electrical terminating portion of each of a pair of electrical wires for differential signal transmission; and
an optical terminating portion of an optical fiber for optical signal transmission, the optical terminating portion covered with a ferrule made of an electrically conductive material and arranged in a position separated from the electrical terminating portion of each of the electrical wires by a distance producing an impedance matched with an impedance of a portion of each of the electrical wires connected to the electrical terminating portions and extending outside of the optical-electrical hybrid connector.

2. The optical-electrical hybrid connector of claim 1, wherein the optical terminating portion is arranged in a position at equal distances from the electrical terminating portion of each of the electrical wires.

3. The optical-electrical hybrid connector of claim 1, wherein an optical terminating portion of each of a pair of optical fibers is arranged in a position at an equal distance from a nearest electrical terminating portion of each of the electrical wires.

4. The optical-electrical hybrid connector of claim 1, wherein the portion of each of the electrical wires extending outside of the optical-electrical hybrid connector is stranded into a twisted pair cable.

5. An optical-electrical hybrid connector, comprising:
a housing;
a pair of electrically conductive contacts retained in the housing and connected to a pair of electrical terminating portions of a pair of electrical wires for differential signal transmission; and
a ferrule retained in the housing and connected to an optical terminating portion of an optical fiber, the ferrule formed of an electrically conductive material and arranged in a position in the housing separated from each of the contacts by a distance producing an impedance matched with an impedance of a portion of each of the electrical wires connected to the contacts and extending outside of the housing.

6. The optical-electrical hybrid connector of claim 5, wherein the ferrule is arranged in a position at equal distances from each of the contacts.

7. The optical-electrical hybrid connector of claim 5, wherein a ferrule of each of a pair of optical fibers is arranged in a position at an equal distance from a nearest contact.

8. The optical-electrical hybrid connector of claim 5, wherein the portion of each of the electrical wires extending outside of the housing is stranded into a twisted pair cable.
